(19) United States
(12) Patent Application Publication
(10) Pub. No.: US 2012/0060147 A1
(43) Pub. Date: Mar. 8, 2012

(54) CLIENT INPUT METHOD

(75) Inventors: Feng Hong, Foster City, CA (US); Quji Guo, Sunnyvale, CA (US)

(73) Assignee: GOOGLE INC., Mountain View, CA (US)

(21) Appl. No.: 12/595,011

(22) PCT Filed: Apr. 8, 2008
(86) PCT No.: PCT/US08/59669

§ 371 Date: Jul. 16, 2010

Related U.S. Application Data
(60) Provisional application No. 60/922,710, filed on Apr. 9, 2007.

(30) Foreign Application Priority Data
Apr. 16, 2007 (CN) 200710101816.3

(51) Int. Cl. G06F 9/44

(52) U.S. Cl. 717/113

(57) ABSTRACT

Methods, systems, and apparatus, including computer program products, in which input method editor code is provided to a client device, and an input method context is received from the client device. A library model for an input method instance based on the input method context is selected. The library model can be utilized to provide input method processing for an input method instance on the client device.

This application claims the benefit of priority of U.S. Provisional Patent application No. 60/922,710, filed on Apr. 9, 2007, and China Application 200710101816.3, filed on Apr. 16, 2007, the entire disclosures of which are incorporated herein by reference.

### BACKGROUND

This disclosure relates to input methods.

Languages that use a logographic script in which one or two characters correspond roughly to one word or meaning have more characters than keys on a standard input device, such as a computer keyboard or a mobile device keypad. For example, the Chinese language contains tens of thousands of characters having pronunciations defined by base Pinyin elements and five tones. The mapping of these potentially many to one associations can be implemented by input methods that facilitate entry of characters and symbols not found on input devices. Accordingly, a Western style keyboard can be used to input Chinese characters. Likewise, input methods can be used for using a Western style keyboard or some other input device to input many other languages that include ideograms, such as the Japanese language, the Korean language, and other languages.

To implement an input method, a user typically must install a client-side software application program and a library. However, such installations can be inconvenient when a user is working on computer devices that do not belong to the user, e.g., a public computer device, or a second computer in a work environment, etc.

### SUMMARY

This specification describes technologies related to input method editors. In some implementations, input method code is provided to a client device, and an input method context is received from the client device. A library model for an input method instance based on the input method context is selected and access to the library model is provided to the client device. The library model can be used to provide input method processing for an input method instance on the client device.

In some implementations, data identifying an input method editor context can be received from a client device. An input method editor library that is optimized for the identified input method editor context can be selected. The selected input method editor library can include associations of composition inputs and characters. Access to the selected input method editor library can be provided to the client device. Input method editor code can be provided to the client device, the input method editor code being configured to generate an input method editor instance at the client device. The input method editor instance is operable to process composition inputs for a plurality of input method editor contexts. The input method editor instance is also operable to process the composition inputs to identify candidate characters according to the associations of composition inputs and characters included in the selected input method editor library.

In some implementations, a system includes a data store and an input method editor engine. The data store is configured to store input method editor libraries, each input method editor library optimized for a corresponding input method editor context, and each input method editor library including associations of composition inputs and characters. The input method editor engine is configured to receive input method editor context data identifying an input method editor context, select an input method editor library that is optimized for the identified input method editor context and provide a client device access to the input method editor library. The input method editor is also configured to provide input method editor code to the client device. The input method editor code is configured to generate an input method editor instance at the client device. The input method editor instance is operable to process composition inputs for a plurality of input method editor contexts, and to process the composition inputs to identify candidate characters according to associations of composition inputs and characters included in the selected input method editor library.

In some implementations, input method code can be received at a client device and executed to instantiate an input method editor instance that can be utilized in a plurality of input method editor contexts. Data identifying the input method context can be provided to an input method editor server, and an input method editor library can be accessed by the input method instance in response. The input method editor library is a contextual library that is optimized for the input method editor context.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment that can be utilized to implement the systems and methods described herein.

FIG. 2 is a flow diagram of an example input method editor process.

FIG. 3 is a flow diagram of another example input method editor process. Like reference numbers and designations in the various drawings indicate like elements.

### DETAILED DESCRIPTION

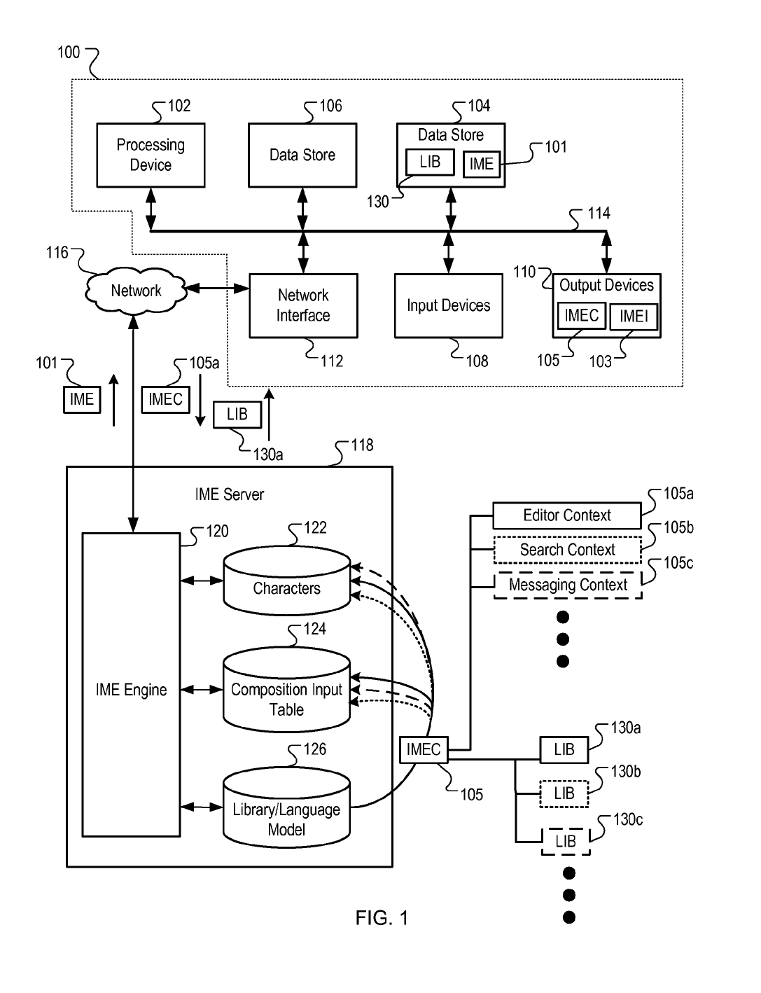

FIG. 1 is a block diagram of an example environment that can be used to implement the systems and methods described herein. The environment can include a client device 100 that can, for example, be a computer device, such as a personal computer device, or other electronic devices, such as a mobile phone, mobile communication device, personal digital assistant (PDA), and the like. The systems and methods herein facilitate the dynamic download of input method editor code and/or one or more input method editor language and library models to a client device. The language and library models can, for example, be selected based on a context detected at the client device.

The example device 100 includes a processing device 102, a first data store 104, a second data store 106, input devices 108, output devices 110, and a network interface 112. A bus system 114, including, for example, a data bus and a motherboard, can be used to establish and control data communication between the components 102, 104, 106, 108, 110 and 112. Other system architectures can also be used.

The processing device 102 can, for example, include one or more microprocessors. The first data store 104 can, for example, include a random access memory storage device, such as a dynamic random access memory, or other types of computer-readable medium memory devices. The second data store 106 can, for example, include one or more hard drives, a flash memory, and/or a read only memory, or other types of computer-readable medium memory devices.

Example input devices 108 can include a keyboard, a mouse, a stylus, etc., and example output devices 110 can include a display device, an audio device, etc. The network interface 112 can, for example, include a wired or wireless network device operable to communicate data to and from a network 116. The network 116 can include one or more local area networks (LANs) and/or a wide area network (WAN), such as the Internet.

In some implementations, the client device 100 can receive input method editor (IME) code 101 from an input method editor (IME) server 118 and store the input method editor code 101 on a data store, such as the data store 104. The input method editor code 101 can include instructions that upon execution cause the processing device 102 to carry out input method editing functions. The input method editor code 101 can, for example, comprise interpreted instructions, such as script instructions, e.g., JavaScript or ECMAScript instructions, that can be executed in a web browser environment. Other implementations can also be used, e.g., a stand-alone application, an applet, a plug-in module, etc.

Execution of the input method editor code 101 generates or launches an input method editor instance 103. The input method editor instance 103 facilitates the processing of one or more input methods at the client device 100, during which time the device 100 can receive composition inputs for input characters or symbols, such as, for example, Hanzi characters. For example, the user can use one or more of the input devices 108 (e.g., a keyboard, such as a Western-style keyboard, a stylus used with a handwriting recognition engine, etc.) to input composition inputs for identification of Hanzi characters. In some examples, a Hanzi character can be composed of more than one composition input.

The IME code 101 can be dynamically provided for any language that utilizes a logographic script. For example, the IME code 101 can be provided in response to an implicit request, such as a user invoking an input method editor function in a web browser, a toolbar, or some other editing environment. In some implementations, the device 100 can receive one or more Pinyin composition inputs and convert the composition inputs into Hanzi characters. The client device 100 can, for example, use compositions of Pinyin syllables or characters received from keystrokes to represent the Hanzi characters. Each Pinyin syllable can, for example, correspond to one or more keystrokes in the Western-style keyboard. Using the Pinyin IME (Input Method Editor), a user can input a Hanzi character by using composition inputs that includes one or more Pinyin syllables representing the sound of the Hanzi character.

In some implementations, processing of an input method is facilitated, in part, by the input method editor server 118. The client device 100 can provide an input method editor context (IMEC) 105 to the input method editor server 118, e.g., provide a data message indicating a particular context. The input method editor context 105 can, for example, define a context in which an input method editor instance 103 is being utilized. For example, a first context 105a can be an editor context, e.g., a web-based word processing environment; a second context 105b can be a search context, e.g., a text entry box for a search engine; a third context 105c can be a messaging context, e.g., an instant messaging editing environment, or an e-mail editing environment. Other input method editor contexts can also be used, such as a map environment, a scripting environment, a chatting environment, or other types of editing environments, and/or a user's input history during a browsing session, and/or a user profile, for example.

The input method editor server 118 can, for example, include an input method editor engine 120, a character data store 122, a composition input data store 124, and library/language model data store 126. Other storage architectures can also be used. The character data store 122 includes characters of a logographic script used in one or more language models. In some implementations, the character data store 122 also includes information about relationships between characters. For example, the character data store 122 can include scores or probability values assigned to a character depending on characters adjacent to the character. Other contextual relation data can also be used.

The composition input data store 124 includes an association of composition inputs and the characters stored in the character data store 122. In some implementations, the composition input data store 124 can link each of the characters in the character data store 122 to a composition input used by the input method editor engine 120. For example, the input method editor engine 120 can use the information in the character data store 122 and the composition input data store 122 to associate and/or identify one or more characters in the character data store 122 with one or more composition inputs in the composition input data store 124.

The library/language model data store 126 can define one or more libraries for a language model, e.g., several libraries can be defined for a Hanzi script. Each library can, for example, define a particular association of the characters 122 and the composition input table 124. In some implementations, a library, e.g., library (LIB) 130, can be selected based on the input method editor context 105. For example, for the input method editor context 105a, which is the editor context, a corresponding word processing library 130a can be selected. The library 130a can, for example, be optimized for a particular context of the input method editor instance 103, e.g., the library 130a for the editor context 105a may be more robust than the library 130b for the search context 105b. For example, a library for a search context 105b may not implement grammar rules and common stop words in the association of characters 122 and the composition input table, as search queries are often not in the form of complete sentences. However, a library for an editor context 105b may implement grammar rules and common stop words, as editors that usually invoke the editor context 105a are typically being used to type complete sentences.

The selected library, e.g., library 130a for the input method editor context 105a, can, for example, be served to the client device 100. Upon receipt of the library 130a at the client device 100, the input method editor instance 103 can select candidate characters based on a composition input and characters adjacent a selected character or adjacent a cursor position. The input method editor instance 103 can receive a selection of a character in the logographic script, such as, for example, a selection of a character to be changed or modified by a user, and subsequent composition inputs. Based on such inputs and selections, a user can enter a desired character in an editing session.

In some implementations, user selections and inputs can be provided from the client device 100 to the input method editor server 118, and the input method editor engine 120 can be configured to provide input method processing for the client device based on the selected library 130.

In some implementations, a toolbar integration provides input method editing capability to online web applications, such as websites with a text box, e.g., by adding a JavaScript snippet into the webpage. Such an implementation can, for example, be used in a browser device and can be integrated with existing online applications. Selection of the toolbar integration can cause a JavaScript script to be loaded that generates an input method editor interface. The input method editor interface can be configured to identify all text input events of a web application and request a library 130 based on the context of the user input. The libraries 130 can be dynamically provided by the input method editor server 118 and may be based on a one or more language models that are trained using, for example, log data that may include web search query and cached documents. Thus the particular library that is requested by the input method editor interfaces or the library that is selected by the server is requested or selected based on the context. Other implementations can also be used, e.g., other layers in a software and/or hardware stack can be used to implement an input method editing environment.

In some implementations, the input method editor server 118 can serve a library 130 adaptively by first detecting or recognizing the context of the user input, e.g., a query or an editing area for e mail. For example, for a search box, the input method editor server 118 may serve a library trained by query data. For a writing or editing area such as an e-mail interface, the input method editor server 118 may serve a library trained by cached documents. The input method editor server 118 libraries may be updated periodically.

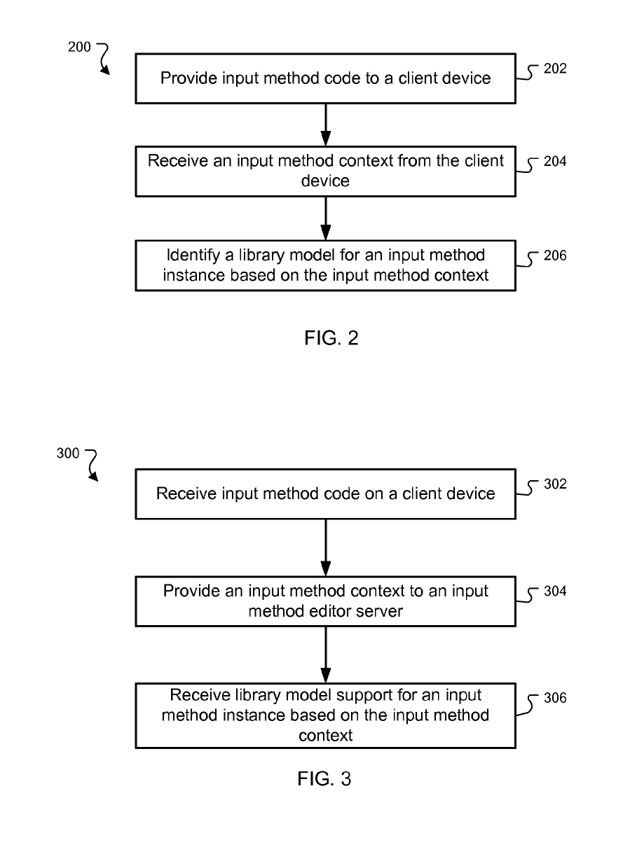

FIG. 2 is a flow diagram of an example input method editor process 200. The process 200 can, for example, be implemented in an environment 100 of FIG. 1.

The process 200 provides input method code to a client device (202). For example, the IME server 118 can receive a request for the input method editor code 101 from a client device 100, and provide the input method editor code 101 to the client device 100 in response.

The process 200 receives an input method context from the client device (204). For example, the IME server 118 can receive an input method context, e.g., a search context 105b, from the client device 100 when a user of the client device 100 attempts to invoke an input method editor process when typing text in a search engine input field.

The process 200 identifies a library model for an input method instance based on the input method context (206). For example, the IME engine 120 can identify a library model, e.g., library model 130b, for the input method editor instance 103 based on the input method context 105b. In one implementation, the input method editor engine 120 can provide input method editor processing for the client device 100. In another implementation, the library 130 can be provided to the client system 100, and the input method editor instance 103 can provide input method editor processing.

FIG. 3 is a flow diagram of another example input method editor process 300. The process 300 can, for example, be implemented in an environment 100 of FIG. 1.

The process 300 receives input method code on a client device (302). For example, the IME server 118 can receive a request for the input method editor code 101 from a client device 100, and provide the input method editor code 101 to the client device 100 in response. The client device 100 can receive the input method editor code 101.

The process 300 provides an input method context to an input method editor server (304). For example, when a user of the client device 100 attempts to invoke an input method editor process when typing text in a search engine input field, an input method editor context, e.g., input method editor context 105b, can be sent to the input method editor server 118.

The process 300 receives a library model for an input method instance based on the input method context (306). For example, for example, the IME engine 120 can identify a library model, e.g., library model 130b, for the input method editor instance 103 based on the input method context 105b. The library 130 can be provided to the client 100, and the input method editor instance 103 can provide input method editor processing.

Although described in the context of particular language and input method examples, the systems and methods described herein can be used for any language that utilizes a logographic script. For example, the systems and methods described herein can be used for many other languages that include ideograms, such as the Japanese language, the Korean language, and other languages.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus. The tangible program carrier can be a propagated signal or a computer readable medium. The propagated signal is an artificially generated signal, e.g., a machine-generated electrical, optical, or electromagnetic signal, that is generated to encode information for transmission to suitable receiver apparatus for execution by a computer. The computer readable medium can be a machine-readable storage device, a machine-readable storage substrate, a memory device, a composition of matter effecting a machine-readable propagated signal, or a combination of one or more of them.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, or declarative or procedural languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter described in this specification have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A computer-implemented method, comprising:
providing input method code to a client device;
receiving an input method context from the client device;
identifying a library model for an input method instance based on the input method context; and
providing the client device access to the identified input method editor library model.

2. The method of claim 1, wherein providing an input method code to a client device comprises providing a browser script to a client device.

3. The method of claim 1, wherein receiving an input method context from the client device comprises receiving an identification of a web page viewed by the client device.

4. The method of claim 1, wherein receiving an input method context from the client device comprises receiving an identification of a toolbar application.

5. The method of claim 1, wherein identifying a library model for an input method instance based on the input method context comprises identifying a search field library model.

6. The method of claim 1, wherein identifying a library model for an input method instance based on the input method context comprises identifying a document editing library model.

7. The method of claim 1, wherein providing input method code to a client device comprises providing input method code defining a Pinyin input method editor to a client device.

8. The method of claim 1, wherein providing input method code to a client device comprises dynamically providing input method code in response to an implicit request.

9. The method of claim 1, wherein the library model is based on a one or more language models.

10. The method of claim 9, comprising training the one or more language models based on search log data.

11. The method of claim 10, wherein the search log data comprises web search queries.

12. The method of claim 1, wherein providing the client device access to the identified input method editor library comprises providing the input method editor library model to the client device.

13. A computer-implemented method, comprising:
receiving data from a client device identifying an input method editor context;
selecting an input method editor library that is optimized for the identified input method editor context, the input method editor library including associations of composition inputs and characters;
providing the client device access to the selected input method editor library; and
providing input method editor code to the client device, the input method editor code configured to generate an input method editor instance at the client device, the input method editor instance operable to process composition inputs for a plurality of input method editor contexts, and to process the composition inputs to identify candidate characters according to the associations of composition inputs and characters included in the selected input method editor library.

14. The method of claim 13, wherein the composition inputs comprise Pinyin inputs and the characters comprise Hanzi characters.

15. The method of claim 13, wherein providing input method editor code to the client device comprises providing a browser script to a client device.

16. The method of claim 13, wherein receiving data from a client device identifying an input method editor context comprises receiving an identification of an editing environment instantiated at the client device.

17. The method of claim 13, wherein providing the client device access to the selected input method editor library comprise providing the selected input method editor library to the client device.

18. A system, comprising:
a data store configured to store input method editor libraries, each input method editor library optimized for a corresponding input method editor context, and each input method editor library including associations of composition inputs and characters; and
an input method editor engine configured to:
receive input method editor context data identifying an input method editor context, select an input method editor library that is optimized for the identified input method editor context and provide a client device access to the input method editor library; and
provide input method editor code to the client device, the input method editor code configured to generate an input method editor instance at the client device, the input method editor instance operable to process composition inputs for a plurality of input method editor contexts, and to process the composition inputs to identify candidate characters according to the associations of composition inputs and characters included in the selected input method editor library.

19. The system of claim 18, wherein the composition inputs comprise Pinyin inputs and the characters comprise Hanzi characters.

20. The system of claim 18, wherein the input method editor code comprises a browser script.

21. The system of claim 18, wherein the input method editor code comprises a toolbar plug-in.

22. A computer implemented method, comprising:
receiving an input method editor code at a client device;
executing the input method editor code to instantiate an input method editor instance that is operable to process composition inputs for a plurality of input method editor contexts;
identifying an input method editor context in which the input method editor instance is being utilized;
providing data identifying the input method context to an input method editor server; and
accessing an input method editor library for the input method instance, wherein the input method editor library is a contextual library that is optimized for the input method editor context.
